(19) United States
(12) Patent Application Publication
(10) Pub. No.: US 2004/0172453 A1
(43) Pub. Date: Sep. 2, 2004

(54) E-mail manager program for a wireless information device

(76) Inventors: Keith De Mendonca, London (GB); Emlyn Richard Howell, Cambs (GB)

Correspondence Address: Richard C Woodbridge, Synnestvedt Lechner & Woodbridge, PO Box 592, Princeton, NJ, 08542-0592, US

(21) Appl. No.: 10/481,732

(22) PCT Filed: Jun. 28, 2002
(86) PCT No.: PCT/GB02/03006

(30) Foreign Application Priority Data
Jun. 28, 2001 (GB) 0115732.0
Sep. 3, 2001 (GB) 0121270.3

(51) Int. Cl. G06F 15/16

(52) U.S. Cl. 709/206; 709/203

(57) ABSTRACT

A wireless information device programmed with an e-mail manager program that deletes the body and/or an attachment to an e-mail message cached locally on the device, leaving the header information, in order to free up memory space in the device. The header information typically includes information such as sender's name, the e-mail message subject and the date of the e-mail message. With the present approach, it is not necessary to delete entire e-mail messages in order to free up memory space on the WID, nor is it necessary to impose restrictions on e-mail functionality, such as prohibiting the receipt of attachments by a WID. Instead, users can manually (or the WID itself can automatically) delete all but the header information of e-mails stored locally on the WID. This allows offline operations to be performed on the incomplete e-mail (e.g. sorting, moving, replying etc.). The original e-mail can also be re-populated with the deleted content when synchronising with the original mail server.

### BACKGROUND OF THE INVENTION

1. Field of the Invention

This invention relates to an e-mail manager program for a wireless information device receiving e-mail from a remote mail server. The term ‘wireless information device’ used in this patent specification should be expansively construed to cover any kind of device with two way wireless information capabilities and includes without limitation radio telephones, smart phones, communicators, personal computers, computers and application specific devices. It includes devices able to communicate in any manner over any kind of network, such as GSM or UMTS, CDMA and WCDMA mobile radio, Bluetodth, 802.11, IrDA etc.

2. Description of the Prior Art

Wireless information devices (‘WIDs’), typically portable computers or smart phones, generally offer an e-mail application. In most corporate set-ups, mail is downloaded to a mail server which the WID connects to in order to download e-mail; the connection may be transient or always-on. The remote e-mail server keeps a master copy of all e-mails sent to and from each connected WID. Each WID downloads its mail when it connects to and synchronises with the mail server.

Memory constraints can be quite severe on WIDs and it is therefore important to provide a mechanism that reduces the amount of memory space occupied by e-mails, but does so in a manner that users can readily understand and operate.

Conventional systems address this problem by requiring a user to delete the entire e-mail (i.e. header plus body and attachments); if the user subsequently wishes to look at that e-mail again, he has to resynchronise with the mail server to download a new copy. This is potentially irritating to users, not least because going through long lists of e-mail and deleting less important messages is time consuming. The deletion of entire e-mails may be a frequent process for users with limited memory or who receive large numbers of e-mails that rapidly fill the available memory.

Another prior art approach to reducing the memory overhead of e-mails is to impose severe restrictions on the e-mail functionality at the device (e.g. prohibiting any attachments, which are potentially large in size). Again, this approach may be very inconvenient to users.

### SUMMARY OF THE PRESENT INVENTION

In a first aspect of the invention, there is provided a wireless information device which acts as a client device to receive e-mail from a remote mail server, characterised in being programmed with an e-mail managet program that deletes the body and/or an attachment to an e-mail message, stored locally on the device leaving the header information, in order to free up memory space in the device.

The header information typically includes basic information such as the sender's name, the e-mail message subject and the date of the e-mail message. It is in essence the envelope which contains the message content and enables the message to be delivered to the correct addressee.

With the present approach, it is not necessary to delete entire e-mail messages (or ‘e-mails’) in order to free up memory space on the WID, nor is it necessary to impose restrictions on e-mail functionality, such as prohibiting the receipt of attachments by a WID. Instead, users can manually (or the WID itself can automatically) delete all but the header information of e-mails cached locally on the WID. The term ‘cached’ is used since a locally stored e-mail duplicates (at least in part) the corresponding e-mail stored on a remote mail server.

This approach can significantly reduce the memory space occupied by an e-mail but still allow a user to perform many useful e-mail functions. For example, If an e-mail with a large attachment is received at the WID, a user can decide that he does not need the attachment stored on the WID after viewing the attachment; the attachment alone can be deleted, leaving the body of the e-mail and its header. The e-mail is then marked as ‘incomplete’ in the list of e-mails displayed on the WID; offline operations (i.e. operations which do not require a live connection to the mail server) can still be performed on the e-mail such as moving it into an appropriate folder, drafting a reply to it, sorting using filters applied to the header information, deleting the ‘master’ copy of an e-mail held at the mail server etc.

The e-mail message may comprise content in any format, such as text, images, speech and music. The ability to selectively retain only header information can be particularly useful with some non-text categories of e-mail, such as picture messages (e.g. electronic images sent between mobile telephones equipped with cameras—these may have no text content at all). Picture messages (usually in MIME format) can occupy considerable space and it is important to offer a simple to use method which allows users to keep the memory taken up by these images on their WIDs at acceptable levels. With the present invention, it is possible for a WID to download picture messages to the WID) but to apply (manually or automatically) rules based on the frequency of viewing or e-mail age to determine how important it is to retain the image on the WID and to prompt a user whether the image can be removed from the WID. But importantly, if the user does delete a picture, his WID nevertheless retains the header from the original message, making it easy for the user to obtain the picture again from the mail server (assuming it is retained there) by simply selecting the original picture message and then setting the WID to re-acquire the picture (e.g. when it nest synchronises) and hence re-populate the original e-mail. This allows a user to oppose incoming picture messages into folders etc. knowing that even though the pictures associated with the messages may not be stored locally on the WID, it is simple to have them returned to the WID.

Conventional systems however require an entirely new copy of the whole message to be downloaded from the mail server, making organising messages into folders time consuming. Also, many users do not organise messages into folders but instead keep all incoming e-mail in a single list, relying on filters (e.g. subject, from, to, date etc.) to locate relevant e-mails. The present invention allows users to continue us this approach, since, unlike prior art approaches in which the entire e-mail stored locally on a WID is deleted, only the body and/or attachments are deleted: the header information on which filters (e.g. subject, from, to, date etc.) act is retained.

In another aspect, there is a method of managing e-mail received at a wireless information device which acts as a client device to receive e-mail from a remote mail server, characterised in that the method comprises the step of deleting the body and/or an attachment to an e-mail message stored locally on the device, leaving the header information, in order to free up memory space at the device.

In a final aspect, there is computer software programmed to delete the body and/or an attachment to an e-mail message stored locally on a wireless information device which acts as a client device to receive e-mail from a remote mail server, leaving the header information, in order to free up memory space at the device.

### DETAILED DESCRIPTION

An implementation of the present invention is available on the Symbian OS operating system for communicators and smart phones, available from Symbian Limited of London, United Kingdom. In this system, e-mail body text and/or attachments can be deleted (manually, or automatically through useage based rules or time schedules) from e-mail messages received and stored locally on a device, but can subsequently be retrieved from the remote mail server which sent the messages. This allows scarce memory on the local device to be freed up, yet (a) allows a user to perform offline operations on the e-mail which require only header information (e.g. sorting into folders; drafting a reply etc.) and (b) allows the body and/or attachments to be readily retrieved and returned to the original e-mail on the device and not into an entirely new e-mail. It works by separating the e-mail envelope information from the body data so that the body data can be deleted independently from the envelope. After the body data has been deleted the e-mail entry is returned to the state it was in after synchronisation but before the e-mail body data was downloaded. It is marked as ‘incomplete’ but remains visible to a user.

The present invention is implemented in the Nokia 9210 communicator; its operation can be seen if one fetches an e-mail over POP3 or IMAP4 and then goes offline. If a user tries to delete an e-mail when offline, then the e-mail is still displayed in the list view of received e-mails, and can still be selected for offline operations, but the body has been deleted from the device and the disk space freed up. Also, if several e-mails are fetched from a mail server and the option ‘remove now’ is selected form the ‘Tools’ drop down menu, then all of the e-mail bodies that have been downloaded will be removed. Disk space is freed up but the e-mails still appear under the remote service and no subsequent synchronisation is needed to perform operations such as copy/move to a different folder or directory, delete from the mail server, repopulate the message.

The actual APIs used for the Symbian OS implementation are described in the following section.

Disconnected Mode Cache Management APIs

A mailbox on a local WID that is being used in disconnected mode (i.e. not connected to a mail server) will allow the user access to message data by opening the message directly from the mailbox. If the required message has been downloaded previously then it will not necessarily need to be downloaded again. This functionality is achieved by preserving the message data locally at the WID, under the remote service entry. The preserved message data acts as a cache to allow the user access to the message without the need for it to be downloaded every time.

Cache management functionality is however required to reduce the amount of memory that is consumed by the message cache. This is achieved by deleting the body text and the attachment data from the appropriate messages. It should be noted that, while the text and attachment data is deleted, the structure of the message is preserved locally at the WID. It is also possible to delete the structure too, leaving only the top level header information (e.g. sender, subject, date sent etc.).

Deleting more message data will free up more memory but there is a higher chance that a user will need to download a message for a second time. The cache management implementation gives the user the chance to implement an appropriate filter in order to decide which messages are processed, for example it could be restricted to ‘all read messages over a week old,’ or, ‘all read messages, over 20K in size which are also over a day old.’

Several classes are exported by the cache management API, however the most commonly used will be CImCacheManager.

CImCacheManager

This class provides a mechanism for asynchronously traversing a message tree and for removing the text and attachment data from appropriate messages. It is an abstract base class and therefore the caller must derive from it, implementing the Filter function, before it can be used.

```
class CImCacheManager : public CMsvOperation
    {
public:
    IMPORT_C void StartL(TMsvId aRootEntry,
    TRequestStatus &aStatus);
    IMPORT_C const TDesC8& ProgressL( );
protected:
    IMPORT_C void ConstructL( );
    IMPORT_C CImCacheManager(CMsvSession& aSession,
TRequestStatus& aObserverRequestStatus);
private:
    virtual TBool Filter( ) const = 0;
protected:
    CMsvEntry* iCurrentEntry;
StartL
void StartL(TMsvId aRootEntry, TRequestStatus &aStatus)
This function is called to start the cache management operation.
It will recursively process the messages starting from the given root entry.
```

| | |
|---|---|
| TMsvId aRootEntry | Specifies the entry from which to start, all sub- |
| | entries will be searched. |
| TRequestStatus &aStatus | Set to KErrNone after the operation has |
| | completed without error. |

```
ProgressL
const TDesC8& ProgressL( )
Returns a package buffer that can be cast to the following progress
structure:
struct TImCacheManagerProgress
    {
    TInt iTotalMessages;
    TInt iMessagesProcessed;
    };
```

Immediately after the CImCacheManager object is started the progress operation may return 1 for iTotalMessages and 0 for iMessagesProcessed regardless of the total number of messages. This is because the counter for the iTotalMessages operates asynchronously and may not have counted all of the messages at that time. The ratio between iTotalMessages and iMessageProcessed will always be correct for a gauge type dialog and iTotalMessages will never be 0 in order avoid possible divide by 0 errors.

Filter

virtual TBool Filter&Ovalhollow; const=0

This function must be implemented in any classes derived from CImCacheManager. After the StartL command has been issued this function is called once for each message entry. This function should return ETrue if the body text and attachment data belonging to the current message (iCurrentEntry) should be deleted. It should return EFalse if the current message is to be left intact.

ConstructL

void ConstructL&Ovalhollow;

All classes derived from CImCacheManager must call this function before the StartL function is invoked.

CImPruneMessage

This class is used internally by CImCacheManager and need not be used in conjunction with it. This class is exported in order to provide functionality for removing the body text and attachment data from an individually specified message. CImPruneMessage could be used after a populating operation has failed. It could be used to remove body text and attachment data from remote messages, whilst preserving the message structure.

```
class CImPruneMessage : public CmsgActive
    {
public:
    IMPORT_C static CImPruneMessage* NewL(CMsvEntry&
    aEntry, RFs& aFs);
    IMPORT_C static CImPruneMessage* NewLC(CMsvEntry&
aEntry, RFs& aFs);
    IMPORT_C void StartL(TMsvId aMessageEntry,
    TRequestStatus &aStatus);
NewL, NewLC
static CImPruneMessage* NewL(CMsvEntry& aEntry, RFs& aFs);
static CImPruneMessage* NewLC(CMsvEntry& aEntry, RFs& aFs);
Create the CImPruneMessage object.
```

| | |
|---|---|
| CMsvEntry& aEntry | The CMsvEntry that is used to remove the text |
| | data and to locate the attachment files. |
| RFs& aFs | The file system handle. Needed for deleting the |
| | attachment file. |

StartL
void StartL(TMsvId aMessageEntry, TRequestStatus &aStatus);
Starts the CImPruneMessage object.

| | |
|---|---|
| TMsvId aMessageEntry | The TMsvId of the entry from which the body |
| | text and attachment data is to be removed. |
| TRequestStatus &aStatus | Completes with KErrNone if the body text |
| | and all of the attachments have been deleted. |

1. A wireless information device which acts as a client device to receive e-mail from a remote mail server, characterised in being programmed with an e-mail manager program that deletes the body and/or an attachment to an e-mail message, stored locally on the device, leaving the header information, in order to free up memory space in the device.

2. The device of claim 1 in which the e-mail manager program is manually initiated by a device end-user.

3. The device of claim 1 in which the e-mail manager program is automatically initiated and operates using predefined rules which cause the body and or an attachment to one or more e-mails to be deleted if pre-defined conditions are satisfied.

4. The device of claim 1 in which the pre-defined conditions relate to the age of the e-mail and/or its size.

5. The device of claim 1 in which the body and/or attachment can be retrieved from the remote mail server to re-populate the original e-mail message.

6. The device of claim 1 in which the header information can be used to perform offline operations.

7. The device of claim 1 in which the offline operations include one or more of the follow,
(a) fitting
(b) moving
(c) replying
(d) deleting from a mail server at a later time.

8. The device of claim 1 in which the e-mail message comprises content in any format.

9. The device of claim 1 which the content format is one or more of the following:
(a) text
(b) images
(c) speech
(d) music

10. A method of managing e-mail received at a wireless information device which acts as a client device to receive e-mail from a remote mail server, characterised in that the method comprises the step of deleting the body and/or an attachment to an e-mail message stored locally on the device, leaving the header information, in order to free up memory space it the device.

11. Computer software programmed to delete the body and/or an attachment to an e-mail message stored locally on a wireless information device which acts as a client device to receive e-mail from a remote mail server, leaving the header information, in order to free up memory space at the device.
